(19) United States
(12) Patent Application Publication
(10) Pub. No.: US 2014/0144196 A1
(43) Pub. Date: May 29, 2014

(54) ORGANIC WATER RETENTION MIX FOR USE ON SOIL

(71) Applicant: Hector Luis Correa Delgado, Wheaton, IL (US)

(72) Inventor: Hector Luis Correa Delgado, Wheaton, IL (US)

(21) Appl. No.: 14/131,177

(22) PCT Filed: Jul. 6, 2012
(86) PCT No.: PCT/US2012/045866

§ 371 Date: Jan. 6, 2014

Related U.S. Application Data
(60) Provisional application No. 61/505,094, filed on Jul. 6, 2011.

(51) Int. Cl. C05G 3/04

(52) U.S. Cl. CPC C05G 3/04
USPC 71/23

(57) ABSTRACT

An organic water retention mix for use on soil includes paper sludge, dry sawdust or wood shavings, and muds obtained from the sediments of the water recycling plants and optionally limestone. The combination is mixed until the particle diameter size is between about 0.2 cm and about 1.5 cm to create a product that retains several times its dry weight in water and maintains high levels of humidity for long periods of time, transferring it gradually to the soil and subterranean layers of the soil where it is applied, whether soil is used for farming, grazing or forest soils, parks or recreational areas.

### TECHNICAL FIELD

This invention is in the field of products to improve soil water retention. Specifically a product and method of making it utilize a variety of organic waste products to accomplish this purpose. The prior U.S. Provisional Patent Application No. 61/505,094, filed 6 Jul. 2011 is hereby incorporated by reference.

### BACKGROUND

There exist products in the market that improve water retention on soils. Some of them are gels, silicon beads or other compounds based on petroleum or oil derivatives. These products are not only based on non-renewable resources but some also require special handling and application procedures since they contain chemical agents that can be hazardous if long term exposure or mishandling occurs during its storage or application. Most of these products cannot be used on large farming or forest areas due to their high cost. Even if their cost is reduced through more efficient processes or subsidies, many of the existing products contain chemical agents that make them unsuitable or are not recommended for use in some crops. Existing products in this category use expensive, non-renewable raw materials such as petroleum, or chemical compounds that make them hazardous for use in farming land or for human consumption crops.

There are also some organic materials that are used to aid in water retention on soils. These include compost, mulch and other mineral based products.

Compost is obtained from the decomposition process of organic waste assisted by waste-digesting worms and/or bacteria that accelerate the process of decomposition. Worms and bacteria accelerate this process creating an organic mass rich in nutrients that has some water retention capabilities. In some regions in the southwestern United States, compost is used as an aid in the maintenance of golf courses. Nevertheless, the production cycle for compost is extremely long, the production of a metric ton of compost requires months of decomposition of organic material, and it is a process that cannot be industrialized easily. These factors increase the cost of the compost and make the production volumes small. Even though compost is an organic and renewable alternative, important limitations in production capacity and the elevated cost related to its production hamper its viability as an option to reduce water consumption. Decreasing water consumption is increasingly important for large arid regions with a strong population growth and a growing demand for water.

Mulch is usually obtained from bark, compost, grass clippings or straw and is spread or laid over the surface of the soil as a covering. It retains moisture in the soil, suppresses weeds, keeps the soil cool and makes garden beds look more attractive. Organic mulches also help improve the soil's fertility, as they decompose. Compost and mulch have low water retention compared to their weight or volume. Both materials, compost and mulch, also lose accumulated moisture at a much higher rate.

Other products use sugar cane fibers obtained from the waste of sugar cane mills, and these fibers are used in fertilizers to aid in the decomposition and absorption process of the nutrients present in fertilizers. These fibers are very long not effective at water retention.

Algae have also been used as a water retention agent in other products. Algae may be cooked, dried, pulverized and processed with hydrogen peroxide to create a gel. When the gel is added to a fertilizing mix it is expected to impart water retention capabilities. However, I have found no information on algae's water retention. Even if the gel were absorbent, it generally has little effect because the gel is used in such low amounts (e.g., 3 to 10 grams per 5 kilos of mix).

Other products use manure as an agent to fertilize or improve farming soil. The manure comes from different sources, for example, birds or bats, and has a different chemical composition from cow manure. Frequently manure undergoes a series of chemical or industrial processes such as pasteurization, fermentation in water or gels, and the addition of bacteria to speed fermentation and effectiveness of fertilization properties.

### SUMMARY

In one embodiment, there is disclosed an organic water retention mix for use in soils that includes cellulose fiber waste or paper sludge; sawdust or wood shavings; water recycling sediment (mud); and limestone. Optimally the mixture includes 40 kg to 75 kg of paper sludge; 10 kg to 30 kg of dry sawdust or wood shavings; 10 kg to 40 kg of mud; and 10 kg to 30 kg of limestone. Preferably, the paper sludge content is about 60 kg. Preferably, the dry sawdust or wood shavings content is about 22 kg. Preferably, the mud content is about 20 kg. Preferably the limestone content is about 20 kg. In a preferred embodiment, the limestone is dust and particles of less than about 1 cm in diameter.

In another embodiment, there is disclosed a method of making an organic water retention mix for use on soil. The method includes providing about 40 kg to 75 kg of paper sludge, about 10 kg to 30 kg of dry sawdust or wood shavings, about 10 kg to 40 kg of mud, and about 10 kg to 30 kg of limestone; adding the paper sludge, to the dry sawdust or wood shavings, to the mud, and limestone; and mixing by mechanical agitation for a period of about 28 to 35 seconds. Preferably the mixing step lasts about 30 seconds. Even more preferably, the mixing step lasts until the mix has particles of about 0.2 cm to about 1.5 cm.

In another embodiment, there is disclosed an organic water retention mix for use in soils with cellulose fiber waste or paper sludge; dry sawdust or wood shavings; and sediment of a water recycling plant (mud). Preferably the water retention mix has proportions of about 40 kg to about 75 kg of cellulose paper sludge; about 10 kg to about 30 kg of dry sawdust or wood shavings; and about 10 kg to about 45 kg of mud. Preferably the paper sludge used in the mix has a water percentage of about 15% to about 55%. Preferably, the water percentage comprises about 15%. Preferably the mud used in the mix has a percentage of water of about 20% to about 58%. Preferably, the water percentage is about 35% to about 45%. Preferably, the paper sludge comprises about 60 kg and prior to addition to the mix the water percent comprises about 15% to about 55%. Preferably, the dry sawdust or wood shavings content is about 22 kg. Preferably, the mud is about 30 kg and its water percent prior to addition is about 20% to about 58%.

In yet another embodiment there is disclosed a method of making an organic water retention mix that lacks limestone for use on soil. This method including providing about 40 kg to 75 kg of cellulose fiber waste or paper sludge, about 10 kg to 30 kg of dry sawdust or wood shavings, and about 10 kg to 40 kg of sediment of water recycling (mud); drying the paper sludge to about 15% to about 55% water and the mud to about 20% to about 58% water; adding the cellulose fiber sludge to the dry sawdust and the sediment to form a combination; and mixing the combination by mechanical agitation for a period of 28 to 35 seconds. Preferably the step of mixing lasts about 30 seconds. More preferably, the mixing step lasts until the mix has particles of about 0.2 cm to about 1.5 cm.

### BRIEF DESCRIPTION OF THE FIGURES

For a further understanding of the objects and advantages of the present invention, reference should be had to the following detailed description, taken in conjunction with the accompanying drawing, in which like parts are given like reference numbers and wherein:

FIG. 1 shows the beginning and final weights of the cellulose fibers from paper sludge after being dehydrated in a laboratory stove, indicating typical humidity of samples from paper mills.

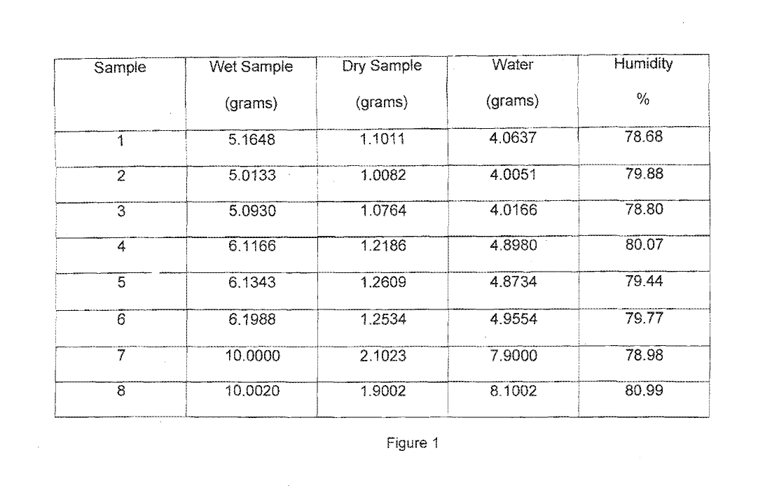

FIG. 2 shows the initial and final wiehgts of the waste-water muds after being dehydrated in a laboratory stove and the calculated percent humidity of mud samples from water recycling plants.

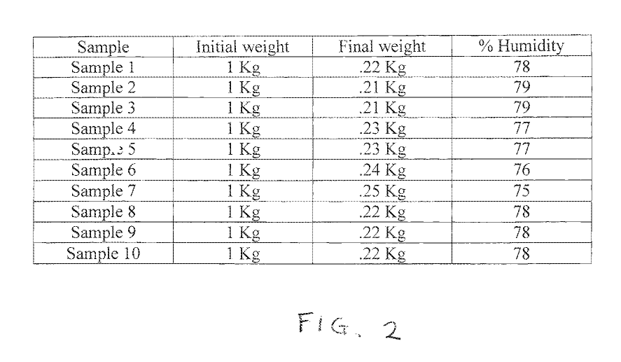

FIG. 3 shows the chemical analysis (characterization) of the organic water retention mix for use in soil.

### DETAILED DESCRIPTION OF THE INVENTION

I have created two new formulas that primarily use paper sludge and water recycling muds, each one with different characteristics. In my new mixes, I no longer use manure or topsoil. I developed my new mixes to reduce water use in irrigation and keeping in mind the advantages and disadvantages of existing products. These inventions utilize not only paper sludge but also the sediment from water recycling plants, which mixed with other natural materials both aid in water retention on arid or drought areas to improve the performance of farming, grazing and forest soils as well as to help reduce water consumption in city parks and recreation areas and domesticated green areas.

The objective of the current inventions are to develop an organic water retention mix for use on soil capable of reducing the levels of water evaporation observed in arid regions. The mixes are based on cellulose polymers and other materials that help retain water on arid soils or drought areas. These factors help boost production when used in farming, forest or grazing soil increasing its productivity. In the same way, this mix helps reduce water consumption in city parks and recreation areas or any other soil.

I previously received U.S. Pat. No. 8,083,829 for a water retention product. As improvements over my previous invention, the new formulas presented herein provide the following important improvements:
Increased the water retention capability
Eliminated one of the non-recycled raw materials used in the previous formula
Eliminated or replaced one of the recycled materials that is difficult to find
Increased the percentage of bacteria that the mix transfers to the soil to improve the soil's constituency
Produced with better granularity for better spreading and water functionality

A primary component in the organic water retention mix is the waste from the paper recycling or paper production process herein described as cellulose fiber waste, “paper sludge,” or “sludge.” This sludge is composed of short cellulose fibers with a high capacity for moisture absorption from the surrounding environment. This sludge also retains moisture for long periods of time. This cellulose fiber sludge in combination with other materials discussed below, forms a new compound or mix that has higher capacity to store moisture for later transfer to the soil on which the mix is applied. The mix further improves the mechanical characteristics of the soil, improves pH levels, and also aids in improving the biological and physiological characteristics of the soil by creating a favorable environment for microorganism growth in the soil.

This main component of sludge (besides water) is a polymer with hygroscopic properties present in the cellulose fibers that give it a great capacity to absorb, retain, and transfer water to the soil slowly and progressively. This material retains four to five times its dry weight in water which is later slowly transferred to the soil. During this transfer process, we surprisingly found that the sludge also helps increase the temperature and percentage of moisture in the soil aiding in the growth and development of plants for long periods of time that range from 10 to 15 days, therefore, reducing maintenance and preventive irrigation costs, as well as energy consumption, and water.

It is important to list the differences between the paper mill waste used in this mix and the ordinary paper waste or paper that is pulverized to a certain size. I will describe in detail the components in the following paragraphs.

During the recycling process for paper or cardboard, the paper/cardboard is cleaned, washed and stripped of any other materials like ink, glue or plastic films that have been applied previously. After this step, the material is pulverized to a standard size. Paper or cardboard can be recycled several times, but during every cycle, the paper fibers are broken to ever smaller sizes. For paper fibers to reattach together and create new sheets of paper or cardboard, the fibers must have a minimum length. When the paper fibers are too short to reattach, these fibers are discarded as waste and receive the name “paper sludge,” a term commonly used in the paper industry. This sludge cannot be used anymore to create new paper products and it is usually discarded to landfills or other disposal facilities.

One big advantage of using paper sludge instead of pulverized paper or cardboard is that paper sludge has these short fibers with a bigger capacity to retain water compared to the longer fibers of paper and cardboard. The longer the fiber, the lower is the capacity to retain water. While some water retention products can use pulverized paper or sludge, we prefer only paper sludge for both the lower cost and greater water retention benefits.

However, paper sludge is much more difficult to use in its unprocessed form, as it is a very thick paste, having had much of the water removed and recycled. Still I believed that a beneficial product could be made from paper sludge paste with its very high water percentage. In order to make it more suitable, light and manageable for its final purpose, I tested a number of other components to help break up the paste.

The instant invention comprises a highly beneficial, additional component. The new invention also incorpoates the “mud” that is the by-product of water recycling plants. The following paragraph describes in more detail how this “mud” is obtained. Muds are obtained at different stages of the water recycling plants where sedimentation of solids takes place. During this sedimentation process, semi-solids concentrate at the bottom of the sedimentation tanks. After this process, water is separated from the sediments. These semi-solid sediments are processed in aeration tanks or biological reactors to maintain a desired percentage of these solids (micro-organisms) in the water. The rest of the sediments are removed from the process; put through a disinfection process to make sure that viable no bacteria, virus or any other pathogens harmful to humans remain in these sediments; and are later discarded as “mud.” This “mud,” contains high percentages of organic matter for fertilizer. For this reason, this “mud” has been used in the past to increase the percentage of organic matter in soils, but it is not widely used in all regions of the world. An important characteristic of this “mud” is that it retains large amounts of water for long periods of time. However, this material alone cannot be used for water retention or fertilizer because it is very plastic. If applied directly to the soil, the mud creates a thick layer that can suffocate the plants. Therefore, to date it has only been used in small quantities in soil; these quantities have been insufficient to noticeably improve water retention. The mud contains up to 75% to 79% of its weight in water when it leaves the water recycling plant, as can be seen in Table 2.

I have solved these problems. I have combined this “mud” with the paper sludge described in previous paragraphs and other components to increase the water retention of the previous patented formula. These two components (the “muds” and the “paper sludge”) with other materials that are also considered organic waste from other industries, combined in the right proportions create a final material that provides a high water retention capability and provides nutrients to the soils where it is applied.

Another of the components used in this mix is dry sawdust or wood shavings. These components were initially added to absorb some of the moisture from the sludge paste, and now “mud”. The cast-off wood surprisingly eliminates most of the natural odor of the sludge paste. While the odor is not important for its final water retention use, the saw dust or wood shavings eliminate it almost completely and give it a nice wood odor. When entire fields are covered with the inventive mixture, the absence of malodor is important.

I have also added limestone in my mix where it serves different purposes. The granularity of the limestone is very well defined. For this use, the limestone needs to be pulverized to small rocks, about 1 cm or less in size, and powder. The limestone helps break down the paper sludge paste and eliminates the use of topsoil in the earlier patented formula. It also helps neutralize the pH value of the final mix to make it more suitable for arid soils or soils under severe drought.

My new inventive combination of paper waste, water recycling sediment or mud, dry sawdust or wood shavings, and optionally limestone, in the proper quantities can be produced cheaply in very large quantities, and the mechanical and biological properties therein improve and retain the humidity of the soil. In addition, the gradual decomposition and fermentation process of this inventive material on soil releases nutrients that incorporate into the soil and subterranean layers. All these features help promote stronger root systems for grass, trees, crops and other plants.

The organic water retention mix for use on soil is a new compound with high humidity content and rich in organic, 100% natural materials that are highly desirable for use in farming for regular crops, fruit producing trees, grazing and forest land as well as in parks and recreation areas in cities or towns and in any area where it is necessary to increase the percentage of humidity for enhanced fertility of the soil and subterranean layers.

The final product can be used or applied directly over the soil as a top layer that is simply used to cover the surface of the soil, or it can be mixed with or tilled into the top layer of soil that is the target for improvement. It can also be used in pots or in tree ponds above or below the soil. The same process can be used for grass. For optimal humidity retention levels in the soil, it is recommended, regardless of the method chosen for application, that the depth of the layer of this material used at least about 4 cm (1.5 inches). Benefits from applying the mix occur within a depth range of 0.5-7.0 cm, more preferably about 1.5 cm to 5.5 cm and most preferably about 3-4.5 cm.

This mix the benefits of the paper sludge and the water recycling muds when applied on the soil surface where grass roots lie. The combination also benefits the underlying layers of the ground where other types of vegetation such as trees, crops and bushes have deeper roots and obtain nutrients. Because the combination has higher water retention as well as beneficial nutrients, the inventive combination performs the following functions:
Reduce the number and frequency of irrigation cycles.
Improve the texture, structure, porosity, permeability, and density in the soil
Improve the conductivity, plasticity, and capillary capacity of the soil
Improve the pH level in the soil
Create a favorable environment for microorganism and bacteria growth to break down the natural products to absorbable moieties

### EXAMPLE 1

The first inventive combination herein presented (SCML) is an inventive organic water retention mix for use on soil and is composed of the following materials and percentages by weight:
Small cellulose fibrous waste or paper sludge from about 37% to 73%, preferably about 50%.
Dry sawdust or wood shavings from about 14% to 35%, preferably about 18%.
“Muds” from water recycling from about 14% to 33%, preferably about 17%.
Limestone from about 14% to 27%, preferably about 17%.

Preparing the organic water retention mix for use on soil consists of weighing and putting the paper sludge, the dry sawdust or wood shavings, the recycling water mud, and limestone in a horizontal industrial mixer to be mechanically mixed for a sufficient time to break up the sludge and mud with the sawdust and limestone. I have found this typically takes about 25 to 35 seconds, preferably 30 seconds, in our industrial mixer. Basically I ran the mixer until the components are thoroughly mixed and have a granularity or diameters of about 0.2 cm to about 1 cm.

Because of the large percentage of water, the consistency of the water recycling mud is very plastic, which makes it difficult to mix. Another challenge is that the final mix requires a specific granularity to be effective in spreading and humidifying soil. If the proposed component percentages are not well controlled, the resulting mix produces large clusters of material that go from the size of quarters to the size of golf balls and even the size of baseballs. When the mixing process produces material with such large clusters, the clusters absorb water, but the bigger the clusters the less water is released back into the soil. Big clusters of material retain more water in their cores and retain it without releasing it back into the soil. If the clusters are too big, for example, the size of baseball balls, they can even absorb water from the soil instead of transferring water to it. To avoid this problem, I experimented and added additional materials in different amounts until the water recycling mud broke down and achieved the desired granularity. The desired granularity can be expressed in terms of the diameter of the particles of the mix. Preferably most of the particles are in the range of about 0.1 cm to about 2 cm, and more preferably 0.2 cm to about 1.5 cm.

The sawdust or wood shavings used in the mix appeared to absorb some of the water from the sludge paste. Recycled wood particles also eliminate most of the natural odor of the sludge paste. While the odor is not important for its water functionality, the saw dust or wood shavings reduce the natural odor and give it a nice wood smell, which is more acceptable to consumers and neighbors of the application area.

The limestone serves a similar purpose to the saw dust. The limestone used herein is ground down to about half a centimeter to about a centimeter in size and contains a high percentage of dust from the grinding process. During the mixing process, the limestone pebbles and powder help to break down the thick paste of mud and paper sludge and to absorb the mud and sludge water.

Our inventive CSML formula has markedly higher water absorption and retention when compared to our earlier formulas. In studies conducted in the field on different types of soil and under different application methods, the new CSML formula increased water savings by 15% to 25% over the previous values observed. This percentage with the new CSML can be translated to an additional total water savings of about 12% to 15%. Our studies also showed that the period of time between irrigations was further extended by about 12% to 22%.

With the earlier formula, the periods between irrigations were extended about 50%. With the new formula, the periods of irrigation can be extended about 60% longer than when no water retention material is used. With the earlier formula we observed water savings of about 35% to 45%. However, this new formula reflects even greater water savings that ranged from 40% to 55% depending on the amount, the method and the soil type. Given that this new formula not only showed improved water savings but also increased time between irrigations, I believe that this new formula has shown important and significant improvements.

### EXAMPLE 2

The second mix (CWM) herein presented has the following composition and percentages:
Cellulose fiber or paper sludge from about 40 to 75 kg (about 36% to 67%), preferably about 60 kg (about 54%) with a percentage of water of about 15% to 55%, preferably about 25%.
Wood shavings or sawdust from wood processes from about 10 kg to 30 kg (or about 9% to 27%), preferably about 22 kg (about 20%).
Mud from water recycling plants from about 10 kg to 45 kg (or about 9% to 40%), preferably about 30 kg (about 27%) with a percentage of water of about 20% to 58%, preferably about 35% to 45% of water.

Preparation of the organic water retention mix for use on soil consists of weighing and putting the paper sludge, the dry sawdust or wood shavings, and the mud in a horizontal industrial mixer to be mechanically mixed for a period of about 25 to 35 seconds, preferably about 30 seconds, or until broken up into small pieces.

Before addition, the paper sludge used in this CWM formula was dried to 25% to 35% of water per kg of material (as opposed to the 80% water per kg of delivered material) to aid in the breakdown of the sludge during the mixing process. While the range of the water percentage is greater as stated in the previous paragraphs, I have recently discovered that the range of 25% to 35% of humidity in the sludge is the optimal for the mixing process, particularly when no limestone is used.

Moreover, the mud from the water recycling plants was also dried to 35% to 45% of water per kg of material (as opposed to the 70-80% of water per kg of delivered material) to aid in the breakdown of the mud during the mixing process. While the usual range of the water percentage is greater as stated in the previous paragraphs, I have found that the range of 25% to 45% water in the mud is the optimal for the mixing process.

Reducing the water in the sludge and mud allowed me to eliminate the limestone from the mix in Example 1, where it was required as a water absorption agent and a separation (breakdown) agent when the sludge and mud have higher percentages of water. Removing the limestone also helps in creating a much lighter mix with increased proportions of material that contributes to water retention.

This second inventive CWM formula also increased water absorption and retention when compared to the earlier formula. In studies conducted on different types of soil and under different application methods, the new CWM formula showed an improvement in water savings of about 10% to 18% over the values previously observed. This percentage can be translated to a difference in total water savings of about 8% to 12%. It also showed that the time period between irrigations was extended in an additional 8% to 16%.

With our earlier formula, the periods between irrigations were extended about 50%. With the new CWM formula, the periods between irrigations can be extended about 56% longer than the between-irrigation period with no water retention material. Our earlier formula showed water savings of about 35% to 45%, while this new CWM formula reflects water savings that range from 35% to 50% depending on the amount, the method and the soil type. Given that this new CWM formula not only increases water savings, increases the times between irrigations, and decreases the use of purchased limestone, I believe that this new formula is an important and significant improvement over earlier formulas.

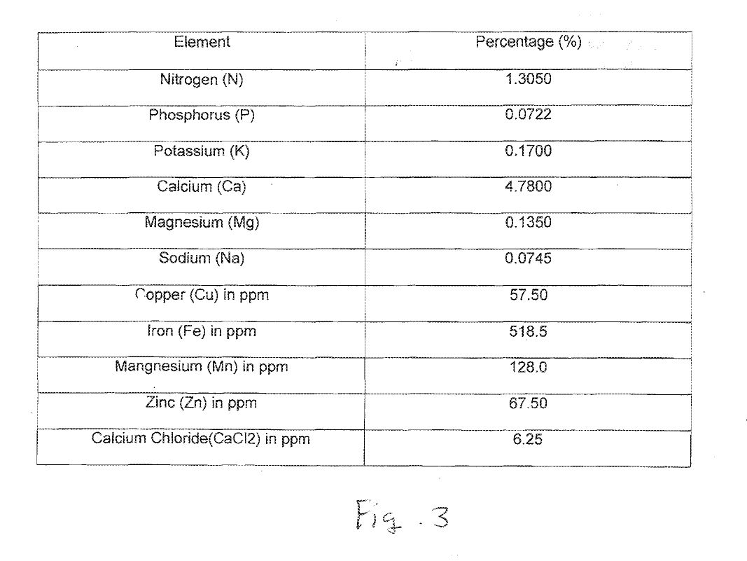

My inventive organic water retention mixes have varied ionic compositions; the ionic composition is the result of the different elements and amounts used in the mix such as the cellulose fiber, dry sawdust or wood shavings, water recycling mud and optionally limestone. These ionic compositions are depicted in FIG. 3.

Although specific embodiments have been illustrated and described herein, those of ordinary skill in the art will appreciate that any arrangement calculated to achieve same purposes can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

In the foregoing description, if various features are grouped together in a single embodiment for the purpose of streamlining the disclosure, this method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims, and such other claims as may later be added, are hereby incorporated into the description of the embodiments of the invention, with each claim standing on its own as a separate preferred embodiment.

1. An organic water retention mix for use in soils comprising
a. cellulose fiber waste or paper sludge;
b. sawdust or wood shavings;
c. water recycling sediment (mud); and
d. limestone.

2. The water retention mix of claim 1 wherein the mix comprises
a. 40 kg to 75 kg of paper sludge;
b. 10 kg to 30 kg of dry sawdust or wood shavings;
c. 10 kg to 40 kg of mud; and
d. 10 kg to 30 kg of limestone.

3. The water retention mix of claim 2 wherein the paper sludge comprises about 60 kg.

4. The water retention mix of claim 2 wherein the dry sawdust or wood shavings comprises about 22 kg.

5. The water retention mix of claim 2 wherein the mud comprises about 20 kg.

6. The water retention mix of claim 2 wherein the limestone comprises about 20 kg.

7. The water retention mix of claim 1 or 2 wherein the limestone comprises dust and particles of less than about 1 cm in diameter.

8. A method of making an organic water retention mix for use on soil, the method comprising
a. providing about 40 kg to 75 kg of paper sludge, about 10 kg to 30 kg of dry sawdust or wood shavings, about 10 kg to 40 kg of mud, and about 10 kg to 30 kg of limestone;
b. adding the paper sludge, to the dry sawdust or wood shavings, to the mud, and limestone; and
c. mixing by mechanical agitation for a period of about 28 to 35 seconds.

9. The method of claim 8, wherein the mixing step lasts about 30 seconds.

10. The method of claim 8, wherein the mixing step lasts until the mix has particles of about 0.2 cm to about 1.5 cm.

11. An organic water retention mix for use in soils comprising
a. Cellulose fiber waste or paper sludge;
b. dry sawdust or wood shavings; and
c. sediment of a water recycling plant (mud).

12. The water retention mix of claim 11 wherein the mix comprises
a. about 40 kg to about 75 kg of cellulose paper sludge;
b. about 10 kg to about 30 kg of dry sawdust or wood shavings; and
c. about 10 kg to about 45 kg of mud.

13. The water retention mix of claim 11 or 12, wherein prior to addition to the mix the paper sludge has a water percentage of about 15% to about 55%.

14. The water retention mix of claim 13, wherein the water percentage comprises about 15%.

15. The water retention mix of claim 11 or 12, wherein prior to addition to the mix the mud has a percentage of water of about 20% to about 58%.

16. The water retention mix of claim 15, wherein the water percentage comprises about 35% to about 45%.

17. The water retention mix of claim 11 or 12wherein the paper sludge comprises about 60 kg and prior to addition to the mix the water percent comprises about 15% to about 55%.

18. The water retention mix of claim 11 or 12 wherein the dry sawdust or wood shavings comprises about 22 kg.

19. The water retention mix of claim 11 or 12 wherein the sediment of the water recycling plants comprises about 30 kg and the water percent comprises about 20% to about 58%.

20. A method of making an organic water retention mix that lacks limestone for use on soil, the method comprising
a. providing about 40 kg to 75 kg of cellulose fiber waste or paper sludge, about 10 kg to 30 kg of dry sawdust or wood shavings, and about 10 kg to 40 kg of sediment of water recycling (mud);
b. drying the paper sludge to about 15% to about 55% water and the mud to about 20% to about 58% water;
c. adding the cellulose fiber sludge to the dry sawdust and the sediment to form a combination; and
d. mixing the combination by mechanical agitation for a period of 28 to 35 seconds.

21. The method of claim 20 wherein the step of mixing lasts about 30 seconds.

22. The method of claim 20, wherein the mixing step lasts until the mix has particles of about 0.2 cm to about 1.5 cm.
